(19) United States
(12) Patent Application Publication
(10) Pub. No.: US 2026/0120128 A1
(43) Pub. Date: Apr. 30, 2026

(54) CONSUMER TENDENCY ANALYSIS AND TYPING SYSTEM AND METHOD THROUGH SMALL DATA EXTRACTION MODEL

(71) Applicant: SALTMINE, INC., Hanam-si (KR)

(72) Inventor: Chang Hyun YOO, Hanam-si (KR)

(73) Assignee: SALTMINE, INC., Hanam-si (KR)

(21) Appl. No.: 19/433,088

(22) Filed: Dec. 26, 2025

Related U.S. Application Data
(63) Continuation of application No. PCT/KR2024/010432, filed on Jul. 19, 2024.

(30) Foreign Application Priority Data
Jun. 20, 2024 (KR) 10-2024-0080297

(51) Int. Cl. G06Q 30/0201; G06F 16/215

(52) U.S. Cl. CPC G06Q 30/02011; G06F 16/215

(57) ABSTRACT

The present invention relates to a consumer tendency analysis and typing system and method through a small data extraction mode, which includes a typing result analysis unit that analyzes what needs consumers of each type classified have, and provides a customized solution for each consumer type, and the present invention classifies and identifies consumers of a client company into 256 types based on their individual tendencies, and enables the client company to provide customized customer services and customized marketing strategies for each consumer type, as well as product recommendations and personalized services.

### CROSS REFERENCE TO PRIOR APPLICATIONS

This application is a continuation application of PCT International Patent Application No. PCT/KR2024/010432 filed on Jul. 19, 2024, which claims priority to Korean Patent Application No. 10-2024-0080297 filed on Jun. 20, 2024 which are all hereby incorporated by reference in their entirety.

### BACKGROUND

The present invention relates to a consumer tendency analysis and typing system and method through a small data extraction mode, and more specifically, to a consumer tendency analysis and typing system and method through a small data extraction mode, which use consumer-related data collected from a client company to type or segment consumers of the client company by tendency and enable customized services for each customer type.

Companies want to accurately identify consumers' needs and establish customized strategies to differentiate services and secure a competitive advantage in the market. In particular, it is essential to meet various needs and expectations of consumers in the midst of rapid change and competition in the digital age. Existing big data analysis is useful in identifying general consumer trends and patterns from vast amounts of data. Through this, companies may establish large-scale marketing strategies, but it has limitations in deeply understanding the inner tendencies and psychological characteristics of individual consumers. Since big data mainly focuses on deriving the characteristics of large groups through statistical correlations, it lacks a personalized approach.

Small data is more useful for identifying and understanding an individual's inner tendencies, tastes, preferences, and psychological characteristics. Small data focuses on identifying who the consumer is by providing data from the perspective of human literacy. For example, big data tells us that “many people buy certain products,” but small data allows us to understand “why certain consumers have purchased these products.” This is useful for deriving individual characteristics through causal relationships in data. Through small data, consumers' inner tendencies can be analyzed and personalized needs can be analyzed.

Patents related to consumer's personal tendency analysis include the following.

Korean patent laid-open publication No. 10-2022-0137233 relates to a product recommendation system based on personal information, which performs statistical analysis using personal information and purchase history of a plurality of customers to generate various types of customer groups and product groups belonging thereto, and, when a product recommendation request is received from a user terminal device, acquires a customer group matching user personal information of the user terminal device and outputs recommended product information. Korean patent laid-open publication No. 10-2022-0137233 classifies and accumulates the personal information and purchase history of a plurality of customers according to various criteria and recommends a product to a customer having similar personal information, thereby providing product information suitable for the lifestyle of the customer.

Korean patent laid-open publication No. 10-2024-0062613 relates to an interior brokerage platform system that provides an interior brokerage service to enable the achievement of desired results for consumers by identifying their interior tendencies. The tendency analysis unit constructs an interior tendency model for each of various interior styles recommended for each living space by an expert group in advance, classifies a test answer of the consumer received through a tendency analysis procedure into a preset answer type, learns a tendency classification method according to matching of the interior tendency model and the answer type using a machine learning model, and groups and classifies the interior tendency model into a plurality of groups according to the tendency classification method.

Korean patent laid-open publication No. 10-2022-0137233 recommends a product based on personal information, wherein the personal information refers to age, gender, occupation, hobbies, marital status, and the like. Personal information-based customer analysis is suitable for big data analysis, but has a problem in that the accuracy of small data analysis is poor.

Korean patent laid-open publication No. 10-2024-0062613 is useful in predicting consumer tendency for interior design to some extent, but has a limitation in that various consumer patterns of companies having various characteristics cannot be analyzed and typed in detail.

Therefore, there is a need for a method of integrating and analyzing various small-scale data such as surveys, feedback, and purchase history to identify and type the psychological characteristics of customers so that companies can more effectively understand their customers, improve services and products based on them, and enable customer management.

### SUMMARY

The present invention has been made in order to improve the above-described problems, and is intended to provide a consumer tendency analysis and typing system through a small data extraction model that can accurately and in-depth analyze the consumer tendencies of a client company by applying data collected from the client company to a small data model and type them by customer characteristics.

The present invention is intended to provide a consumer tendency analysis and typing system through a small data extraction model capable of accurately classifying consumer types of a client company by classifying consumers of the client company into 256 types based on four tendency topics of relationship attitude, way of thinking, decision-making, and lifestyle.

The present invention is intended to provide a consumer tendency analysis and typing system through a small data extraction model, which classifies and identifies consumers of a client company into 256 types, and enables the client company to provide customized customer services and customized marketing strategies for each consumer type.

The present invention has been made in order to improve the above problems, and is intended to provide a consumer tendency analysis and typing system through a small data extraction model that can accurately and in-depth analyze the consumer tendencies of a client company by applying data collected from the client company to a small data model and type them by customer characteristics.

The present invention is intended to provide a consumer tendency analysis and typing system through a small data extraction model capable of accurately classifying consumer types of a client company by classifying consumers of the client company into 256 types based on four tendency topics of relationship attitude, way of thinking, decision-making, and lifestyle.

The present invention is intended to provide a consumer tendency analysis and typing system through a small data extraction model, which classifies and identifies consumers of a client company into 256 types, and enables the client company to provide customized customer services and customized marketing strategies for each consumer type.

According to the present invention having the configuration as described above, the following effects are achieved.

By using zero-party data directly collected from consumers, such as visit records, inquiry records, purchase history, website activities, review data, inquiry and consultation details, and surveys, individual's inner tendencies can be analyzed more accurately and in-depth and typed into a total of 256 types for each customer's characteristics, enabling customized services for each customer type.

Companies can more effectively understand their customers through consumer tendency analysis and typing based on small data, and based on this, they can improve services and products, and establish and implement customized marketing strategies for each consumer type, thereby increasing customer loyalty.

In addition, by using small data rather than big data-based, companies can reduce costs.

### BRIEF DESCRIPTION OF THE DRAWINGS

FIG. 1 is a functional block diagram of a consumer tendency analysis and typing system through a small data extraction model according to the present invention.

FIG. 2 is a detailed functional block diagram of main components included in a consumer tendency analysis and typing system through a small data extraction model according to the present invention.

FIG. 3 is a conceptual diagram of a typing module algorithm based on four tendency topics.

FIG. 4 is a structural diagram of a primary indicator and a secondary indicator for four tendency topics.

FIG. 5 is a conceptual diagram inferring the primary indicator and the secondary indicator using artificial intelligence.

FIG. 6 is a flowchart of a consumer tendency analysis and typing method through a small data extraction model.

### DETAILED DESCRIPTION OF THE INVENTION

In order to achieve the above objects, a consumer tendency analysis and typing system through a small data extraction model according to the present invention is configured to include a small data collection unit that collects consumer-related data of a client company, a small data preprocessing unit that corrects errors and removes duplicates in the collected consumer-related data, and converts the collected consumer-related data into numerical data, a pattern analysis processing unit that analyzes a relationship between preprocessed data using a statistical method to identify a pattern and algorithmizes the identified pattern to primarily type the data, a consumer tendency detailed typing unit that secondarily types the consumer groups primarily typed by the pattern analysis processing unit using a cluster analysis algorithm, and types the secondarily typed consumer groups according to types based on four tendency topics of relationship attitude, way of thinking, decision-making, and lifestyle, and a typing result analysis unit that analyzes what needs consumers of each type classified based on the four tendency topics have, and provides a customized solution for each consumer type.

The same pattern analysis processing unit includes
a pattern correlation analysis module that analyzes a correlation between data through correlation analysis and regression analysis to identify a pattern, and a pattern algorithmization module that formalizes the identified pattern into an algorithm to primarily type consumer-related data.

The consumer tendency detailed typing unit includes a cluster analysis-based consumer typing unit that subdivides the primarily typed data by the pattern analysis processing unit into secondary typing data using a cluster analysis algorithm and a tendency topic-based consumer typing unit that classifies the secondary typing data according to a primary indicator based on the four tendency topics of relationship attitude, way of thinking, decision-making, and lifestyle, and further classifying the secondary typing data according to a secondary indicator to classify a consumer group into a total of 256 types.

The cluster analysis-based consumer typing unit is characterized by secondarily typing a group by subdividing the group within the same pattern of data primarily typed using hierarchical cluster analysis and density-based cluster analysis algorithms.

The tendency topic-based consumer typing unit is characterized by being able to type or segment the customers by classifying the customers into a total of 256 types by classifying the customers into up to 16 types using the primary indicators and classifying the customers into up to 16 types using the secondary indicators, by applying the first indicator, which is divided into two types for each of the four tendency topics of relationship attitude, way of thinking, decision-making, and lifestyle, and then applying the secondary indicator, which is divided into two additional types for each primary indicator.

Specifically, the tendency topic-based consumer typing unit may be configured to include a primary indicator module that types consumer tendency into two types of primary indicators for each tendency topic for the four tendency topics, a secondary indicator module that types the primary indicator into two types of secondary indicators according to the consumer tendency, a primary indicator determination module that determines the primary indicators for each of the four tendency topics by substituting secondary typing data subdivided by the cluster analysis-based consumer typing unit into the primary indicator module, a secondary indicator determination module that determines the secondary indicators for each of the four tendency topics by substituting secondary typing data subdivided by the cluster analysis-based consumer typing unit into the secondary indicator module, and a final typing module that outputs a final typing result by reflecting determinations of the primary indicator and the secondary indicator.

In addition, the tendency topic-based consumer typing unit further includes
a primary indicator learning module that learns, with a first artificial intelligence indicator inference engine, client company information, the secondary typing data subdivided by the cluster analysis-based consumer typing unit, one pre-written question consisting of content associated with the secondary typing data, a primary indicator matched with an answer, and primary indicator determination content of the primary indicator determination module and infers the primary indicators for each of four tendency topics when the client company information and the secondary typing data subdivided by the cluster analysis-based consumer typing unit are input and a secondary indicator learning module that learns, with a second artificial intelligence indicator inference engine, client company information, secondary typing data subdivided by the cluster analysis-based consumer typing unit, three pre-written questions consisting of content associated with the secondary typing data, a second indicator matched with an answer, and second indicator determination content of the second indicator determination module, and infers the secondary indicators for each of four tendency topics when the client company information and the secondary typing data subdivided by the cluster analysis-based consumer typing unit are input, and the final typing module may be configured to output a final typing result by reflecting determinations of the primary indicator inferred by the primary indicator learning module and the secondary indicator inferred by the secondary indicator learning module.

The typing result analysis unit includes a consumer needs analysis module that analyzes the needs of consumers for each type classified by the consumer tendency detailed typing unit and a customized solution providing module that provides a customized solution suitable for the needs of consumers for each type analyzed by the consumer needs analysis module.

Meanwhile, in order to achieve the above object, a consumer tendency analysis and typing method through a small data extraction model according to the present invention is configured to include a first step of collecting consumer-related data of a client company, a second step of correcting an error and removing duplicates in the collected consumer-related data, and converting the collected consumer-related data into numerical data, a third step of analyzing a correlation between data through correlation analysis and regression analysis to identify a pattern, a fourth step of formalizing the identified pattern into an algorithm to primarily type the consumer-related data, a fifth step of subdividing the primarily typed data into secondary typing data using a cluster analysis algorithm, a sixth step of classifying the secondary typing data according to primary indicators based on four tendency topics of relationship attitude, way of thinking, decision-making, and lifestyle, and further classifying the secondary typing data according to secondary indicators to classify a consumer group into a total of 256 types, and a seventh step of analyzing what needs consumers of each type classified based on the four tendency topics have, and providing a customized solution for each consumer type.

Specifically, the sixth step may be configured to include the steps of determining the primary indicators for each of the four tendency topics by substituting secondary typing data into a primary indicator module, determining the secondary indicators for each of the four tendency topics by substituting secondary typing data into a secondary indicator module, and outputting a final typing result by reflecting determinations of the primary indicator and the secondary indicator.

Advantages and features of the present invention, and methods of achieving the same will become apparent with reference to embodiments described below in detail with reference to the accompanying drawings.

However, the present invention is not limited to the embodiments disclosed below, and may be implemented in various different forms.

The embodiments in this specification are provided to make the disclosure of the present invention complete and to fully inform the scope of the invention to those skilled in the art to which the present invention belongs.

In addition, the present invention is only defined by the scope of the claims.

Therefore, in some embodiments, well-known components, well-known operations, and well-known techniques are not specifically described in order to avoid ambiguous interpretation of the present invention.

In addition, like reference numerals refer to like elements throughout the specification, and terms used (described) in the present specification are for describing the embodiments and are not intended to limit the present invention.

In the present specification, the singular forms include the plural forms unless otherwise specified in the phrases, and the components and operations referred to as “comprise (or include)” do not exclude the presence or addition of one or more other components and operations.

Unless otherwise defined, all terms (including technical and scientific terms) used herein may be used in the sense commonly understood by a person of ordinary skill in the art to which the present invention belongs.

In addition, terms defined in commonly used dictionaries are not to be interpreted ideally or excessively unless they are defined otherwise.

Hereinafter, exemplary embodiments of the present invention will be described with reference to the accompanying drawings.

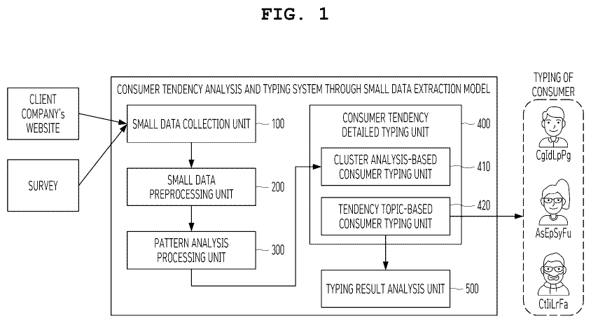

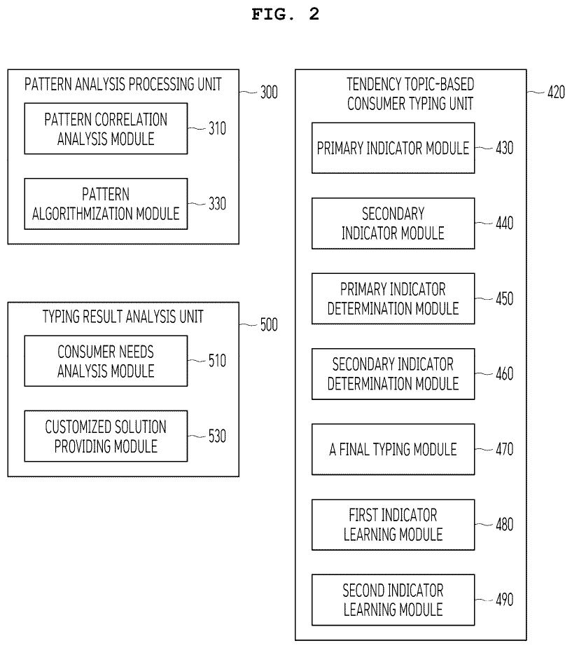

The present invention will be described in detail with reference to FIGS. 1 to 6.

### Consumer Tendency Analysis and Typing System Through Small Data Extraction Model

A consumer tendency analysis and typing system through a small data extraction model according to the present invention includes a small data collection unit 100, a small data preprocessing unit 200, a pattern analysis processing unit 300, a consumer tendency detailed typing unit 400, and a typing result analysis unit 500.

The small data collection unit 100 collects consumer-related data of a client company. Examples of the consumer-related data are as follows.

It collects data on which pages consumers visit on a website or mobile app and which products they view. Through this, consumers' interests and behavioral patterns can be analyzed.

It collects data on which product consumers purchased and which payment method they used. Through this, consumers' purchasing tendencies and preferred payment methods can be identified.

It collects data on when the customer purchased the product and which delivery method they chose. Through this, the pattern of the purchase time zone can be analyzed and the delivery preference can be identified.

It collects reviews left by customers about the products that they purchased. This is useful for identifying product quality, customer satisfaction, and improvements.

The content that customers inquire or consulted is converted into data and stored. Through this, customer problems, needs, service improvements. etc. can be analyzed.

If existing data is insufficient, a survey is conducted on consumers to collect additional data. Through this, more detailed consumer opinions and feedback can be obtained.

The small data collection unit 100 collects consumer-related data of the client company as described above through website and mobile app log analysis, transaction data collection, review and feedback collection, customer consultation data collection, and survey data collection.

The small data preprocessing unit 200 corrects errors and removes duplicates in the collected consumer-related data, and converts the collected consumer-related data into numerical data.

Specifically, the small data preprocessing unit 200 identifies and corrects an incorrect value, an unrealistic value, a missing value, etc. in the collected data. It checks whether data for the same consumer in different databases or sources is consistent and corrects if there is any inconsistency. It identifies duplicate data items for the same consumer. When duplicate data is found, it merges the duplicate records into one consistent data item. It converts categorical data into numerical data suitable for analysis.

The pattern analysis processing unit 300 analyzes the relationship between the preprocessed data using a statistical method to identify patterns and algorithmizes the identified patterns to primarily type the data.

Specifically, the pattern analysis processing unit 300 includes a pattern correlation analysis module 310 and a pattern algorithmization module 330.

The pattern correlation analysis module 310 analyzes the correlation between data through correlation analysis and regression analysis to identify patterns.

For example, it analyzes the correlation between data to identify a pattern in which a customer searches for a brand name or model name of a specific expensive product using a keyword and then purchases the corresponding product.

It identifies the purchase pattern of a customer who only clicks on the top menu of the site and a customer who intensively clicks on specific category pages.

It analyzes the path that a customer takes until the purchase is completed to identify a pattern.

It identifies the purchase pattern of a customer who checks reviews for product purchase and makes a purchase. It identifies the purchase pattern of a customer who searches for a keyword for product purchase, check product specifications, and then make a purchase.

The pattern algorithmization module 330 formalizes the identified pattern into an algorithm to primarily type consumer-related data. Through this, data can be automatically classified and analyzed. Data is typed using a classification algorithm such as a decision tree, a random forest, a support vector machine (SVM), etc.

The consumer tendency detailed typing unit 400 secondarily types consumer groups primarily typed by the pattern analysis processing unit 300 using a cluster analysis algorithm, and classifies the secondarily typed consumer groups according to types based on four tendency topics of relationship attitude, way of thinking, decision-making, and lifestyle.

Specifically, the consumer tendency detailed typing unit 400 includes a cluster analysis-based consumer typing unit 410 and a tendency topic-based consumer typing unit 420.

The cluster analysis-based consumer typing unit 410 subdivides the data primarily typed by the pattern analysis processing unit into secondary typing data using the cluster analysis algorithm.

The cluster analysis-based consumer typing unit 410 subdivides groups within the same pattern of data primarily typed using hierarchical cluster analysis and density-based cluster analysis algorithms and secondarily types the groups.

For example, it derives two groups, such as “high-frequency buyers” and “low-frequency buyers” as a result obtained by analyzing a specific pattern of data primarily typed through hierarchical cluster analysis and secondarily types the two groups. It analyzes specific patterns of data that have been firstly typed through the density-based cluster analysis, and secondarily types the group by subdividing the group within the pattern in a way of grouping into “active searchers” and “negative searchers.”

In summary, the pattern analysis processing unit 300 identifies a basic pattern in the consumer-related data and performs primary typing, and the cluster analysis-based consumer typing unit 410 identifies a deeper level of structure from the primary typing. Among consumers with the same purchase pattern (primary typing), a group with different characteristics in detail (secondary typing) is identified.

For example, it is assumed that data with purchase patterns of types A, B, and C was obtained through pattern analysis. Through cluster analysis, it is possible to subdivide consumers having Type A purchase pattern into groups such as “high-frequency purchasers”, “low-frequency purchasers”, and “new purchasers”. This helps to establish a marketing strategy that is more suitable for Type A consumers.

As such, by sequentially performing two stages (primary typing and secondary typing), the structure of e data can be more clearly understood, and a more sophisticated and effective strategy can be established based on this.

The tendency topic-based consumer typing unit 420 classifies the secondary typing data according to the primary indicator based on the four tendency topics of relationship attitude, way of thinking, decision-making, and lifestyle, further classifies the data according to the secondary indicator, and thereby classifies a consumer group into a total of 256 types.

The tendency topic-based consumer typing unit 420 applies secondary typing data, that is, consumer behavior, purchase pattern, purchase frequency, time spent purchasing, payment style, whether questions are asked, time of purchase, etc. corresponding to secondary typing to a typing module based on four tendency topics of relationship attitude, way of thinking, decision-making, and lifestyle to finally type consumers.

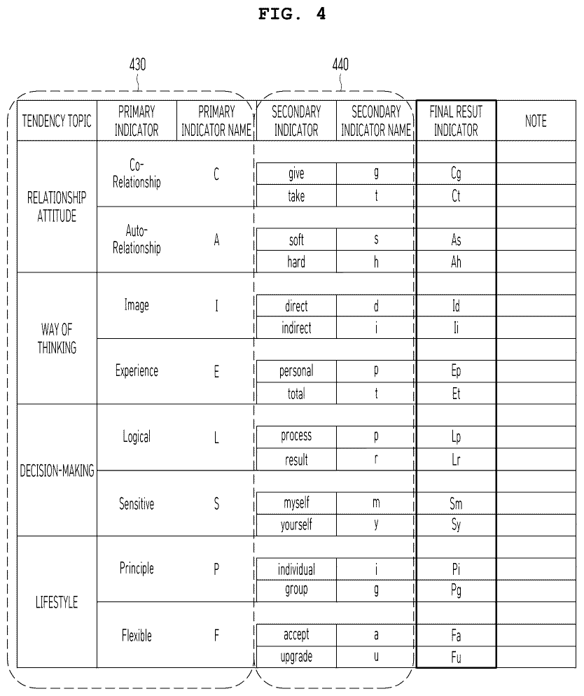

Referring to FIG. 4, it can be seen that the present invention consists of four tendency topics (relational attitude, way of thinking, decision-making, and lifestyle) of the present invention, primary indicators of each tendency topic, and secondary indicators belonging to the primary indicators.

The tendency topic-based consumer typing unit classifies the customers into a total of 256 types by classifying the customers into up to 16 types using the primary indicators and classifying the customers into up to 16 types using the secondary indicators, by applying the first indicator, which is divided into two types for each of the four tendency topics of relationship attitude, way of thinking, decision-making, and lifestyle, and then applying the secondary indicator, which is divided into two additional types for each primary indicator.

As for the primary indicator, a total of 16 cases are obtained by multiplying two relational attitudes, two ways of thinking, two decision-making, and two lifestyles, and by multiplying this by the 16 secondary indicators, consumer groups can be classified into a total of 256 types. This is a key feature of the present invention.

Referring to FIG. 1, as a result of the consumer typing, an example in which three consumers are typed as CgIdLpPg, AsEpSyFu, and CtIiLrFa, respectively, is shown.

The type of CgIdLpPg means that the relationship attitude final result indicator is Cg (primary indicator is C secondary indicator is g), the way of thinking final result indicator is Id (primary indicator is I and secondary indicator is d), the decision-making final result indicator is Lp (primary indicator is L and secondary indicator is p), and the lifestyle final result indicator is Pg (primary indicator is p and secondary indicator is g).

That is, when the tendency topic-based consumer typing unit 420 applies secondary typing data, that is, consumer behavior, purchase pattern, purchase frequency, time spent purchasing, payment style, whether questions are asked, time of purchase, etc. corresponding to secondary typing to a typing module based on four tendency topics of relationship attitude, way of thinking, decision-making, and lifestyle, the tendency of the corresponding consumer is finally typed as CgIdLpPg. CgIdLpPg consumer type is described as below.
Cg: tendency to be influenced by others and tendency to help others
Id: tendency to be imaginative and tendency to think clearly and concisely
Lp: tendency to make rational decisions and value the process rather than the result
Pg: tendency to value principles and to like to get along with others

The present invention is characterized in that behavior data of consumers corresponding to secondary typing is finally typed by matching the primary indicator and the secondary indicator based on four tendency topics of relationship attitude, way of thinking, decision-making, and lifestyle.

For example, the tendency topic-based consumer typing unit 420 may apply consumer behavior, purchase pattern, purchase frequency, time spent purchasing, payment style, whether questions are asked, time of purchase, etc. corresponding to secondary typing to a typing module based on four tendency topics of relationship attitude, way of thinking, decision-making, and lifestyle to final type the consumers, and derive the following insight through the final typing indicator.

Consumer A is a consumer who is heavily affected by others and has an intuitive tendency to purchase furniture, and these consumers prefer a unique and trendy design.

Consumer B is a consumer having a practical tendency with a clear subjective viewpoint, and prefers products with good functionality and convenience.

In this way, tendencies of consumer can be typed into 256 types. Through these results, companies can implement customized marketing strategies for each consumer type. For consumers who prefer a minimalist style, furniture with simple and modern design is recommended, and for consumers who prefer a unique style, furniture with a luxurious and sophisticated design is recommended.

In addition, a recommendation algorithm and UX can be optimized so that convenient online shopping is possible for each customer type.

A detailed description of the tendency topic-based consumer typing unit 420 is as follows.

The tendency topic-based consumer typing unit 420 includes a primary indicator module 430, a secondary indicator module 440, a primary indicator determination module 450, a secondary indicator determination module 460, and a final typing module 470.

Referring to FIG. 4, the primary indicator module 430 types consumer tendency into two types of the primary indicators for each tendency topic for four tendency topics. The secondary indicator module 440 types the primary indicator into two types of the secondary indicators according to tendencies of a consumer.

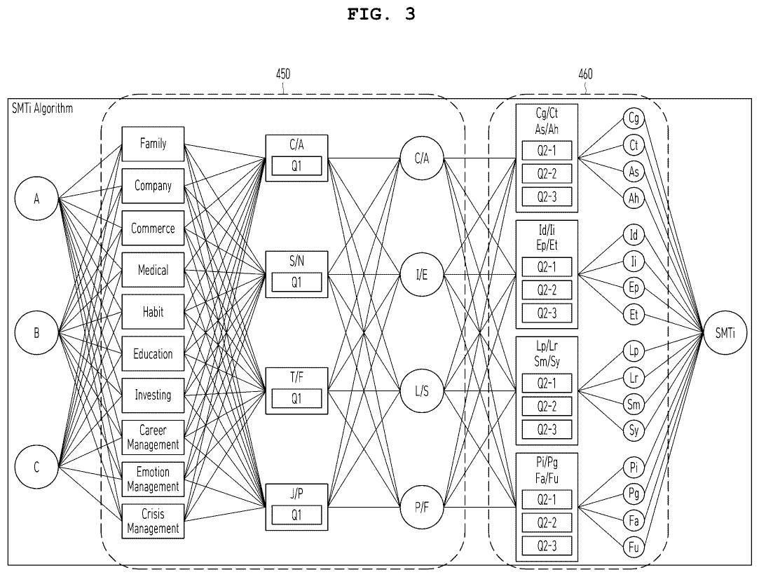

Referring to FIG. 3, the primary indicator determination module 450 substitutes the secondary typing data subdivided by the cluster analysis-based consumer typing unit 410 into the primary indicator module 430 to determine the primary indicator for each of the four tendency topics. That is, the primary indicator is determined based on consumer's behavior data corresponding to the secondary typing.

Consumer's behavior data refers to the product style purchased by the consumer, purchase frequency, time spent purchasing, payment style, whether reviews are checked, whether consultation questions are asked, and the usual time of purchase.

Referring to FIG. 3, when a client company presents consumers with a pre-written question Q1 with which four tendencies on topics related to the client company, such as finance, consumption, learning, health, food, etc., can be checked and the consumer answers the question Q1 (either one or all, etc.), a primary indicator matched with the consumer's answer is determined as a primary indicator of the corresponding consumer based on a primary indicator preset for each answer. That is, the client company conducts a survey of consumers to collect the primary indicators for the four tendency topics of consumers.

Here, the pre-written question Q1 is composed of topics related to the client company and consumer's behavior data corresponding to secondary typing. That is, the question Q1 is asked to consumers about furniture, space, interior design, etc. while a question survey for consumers of a furniture company is conducted, and the question Q1 is composed of content related to consumer's behavior data tailored to the characteristics of the client company among consumer's behavior data corresponding to secondary typing.

The consumer's behavior data is diverse including the product style purchased by the consumer, purchase frequency, time spent purchasing, payment style, whether reviews are checked, whether consultation questions are asked, the usual time of purchase, etc. and since the types of client companies are diverse including interior companies, insurance companies, health food companies, hospitals, etc., the question Q1 is composed of topics related to the client company and consumer's behavior data tailored to the characteristics of the client company.

When the primary indicator is determined for each of the four tendency topics by substituting the secondary typing data subdivided by the cluster analysis-based consumer typing unit 410 into the primary indicator module 430, the primary indicator determination module 450 determines the primary indicators by referring to the primary indicator matched with the answers of the consumers collected for the four tendency topics of the consumers obtained by conducting a survey on consumers by the client company.

Referring to FIG. 3, the secondary indicator determination module 460 substitutes the secondary typing data subdivided by the cluster analysis-based consumer typing unit 410 into the secondary indicator module 440 to determine the secondary indicator for each of the four tendency topics. That is, the secondary indicator is determined based on consumer's behavior data corresponding to secondary typing.

Referring to FIG. 3, as with the first indicators, the survey of the client company's customer is also used for the second indicator.

When a client company presents consumers with pre-written questions Q2-1 to Q2-3 that can check four tendencies on topics related to the client company, such as finance, consumption, learning, health, food, etc., and a consumer answers the questions Q2-1 to Q2-3 (either one or all, etc.), a secondary indicator matched with the consumer's answer is determined as a secondary indicator of the corresponding consumer based on the secondary indicator preset for each answer. That is, the client company conducts a survey of consumers to collect the secondary indicator for the four tendency topics of consumers.

However, in the case of the secondary indicator, unlike the primary indicator, the survey consists of three question and answer methods Q2-1 to Q2-3 (the primary indicator consists of one question Q1 according to each tendency topic-relationship attitude/way of thinking/decision-making/lifestyle), which is designed to enable checking the consistency of consumers'answers to questions about the secondary indicator.

The secondary indicator is determined based on an indicator that receives a majority of responses exceeding half among the answers to the three questions Q2-1 to Q2-3 (e.g., when the primary indicator is C, and among the answers to the three questions for the secondary indicator, one is g and the remaining two are t).

Here, the pre-written questions Q2-1 to Q2-3 composed of topics related to the client company and content related to consumer's behavior data corresponding to secondary typing. That is, the questions Q2-1 to Q2-3 are asked to consumers about furniture, space, interior design, etc. while a question survey for consumers of a furniture company is conducted, and the questions Q2-1 to Q2-3 are composed of content related to consumer's behavior data suitable for the characteristics of the client company among consumer's behavior data corresponding to secondary typing.

The consumer's behavior data is diverse including the product style purchased by the consumer, purchase frequency, time spent purchasing, payment style, whether reviews are checked, whether consultation questions are asked, the usual time of purchase, etc. and since the types of client companies are diverse including interior companies, insurance companies, health food companies, hospitals, etc., the questions Q2-1 to Q2-3 are composed of topics related to the client company and consumer's behavior data tailored to the characteristics of the client company.

When the secondary indicator is determined for each of the four tendency topics by substituting the secondary typing data subdivided by the cluster analysis-based consumer typing unit 410 into the secondary indicator module 440, the secondary indicator determination module 460 determines the secondary indicators by referring to the secondary indicator matched with the answers of the consumers collected for the four tendency topics of the consumers obtained by conducting a survey on consumers by the client company.

If the consumer's behavior data is checked, it is possible to match what kind of tendency the primary indicator is and what kind of tendency the secondary indicator is for each of the four tendency topics.

The final typing module 470 outputs the final typing result by reflecting the determinations of the first indicator and second indicator.

The tendency topic base consumer typing unit 420 includes a first indicator learning module 480 and a second indicator learning module 490.

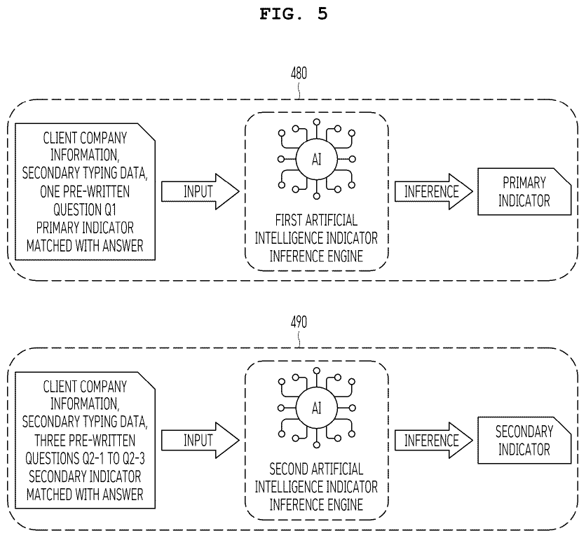

Referring to FIG. 5, the primary indicator learning module 480 learns, with a first artificial intelligence indicator inference engine, client company information, secondary typing data subdivided by the cluster analysis-based consumer typing unit 410, one pre-written question Q1 composed of contents related to the secondary typing data, a primary indicator matched with an answer, and primary indicator determination contents of the primary indicator determination module 450, and when the client company information and the secondary typing data subdivided by the cluster analysis-based consumer typing unit 410 are input, the primary indicator learning module 480 infers the primary indicator for each of the four tendency topics.

It can determine the primary indicator for each of the four propensity topics by learning secondary typing data and corresponding customer information (finance, shopping malls, interior design, education, etc.) through machine learning or deep learning.

The secondary indicator learning module 490 learns, with a second artificial intelligence indicator inference engine, client company information, secondary typing data subdivided by the cluster analysis-based consumer typing unit 410, three pre-written questions Q2-1 to Q2-3 composed of contents related to the secondary typing data, a secondary indicator matched with an answer, and secondary indicator determination contents of the secondary indicator determination module 460, and when the client company information and the secondary typing data subdivided by the cluster analysis-based consumer typing unit 410 are input, the secondary indicator learning module 490 infers the secondary indicator for each of the four tendency topics.

It can determine the secondary indicator for each of the four propensity topics by learning secondary typing data and corresponding customer information (finance, shopping malls, interior design, education, etc.) through machine learning or deep learning.

Of course, sophisticated labeling of the secondary typing data is required for learning.

The typing result analysis unit 500 analyzes what needs consumers of each type classified based on the four tendency topics have, and provides a customized solution for each consumer type.

The typing result analysis unit 500 includes a consumer needs analysis module 510 and a customized solution providing module 530.

The consumer needs analysis module 510 analyzes the needs of consumers for each type classified by the consumer tendency detailed typing unit 400. It can understand the characteristics of each consumer group and clarify the services they demand.

Referring to FIG. 4, when the client customer is an insurance company, for example, when the consumer's primary indicator is C and secondary indicator is t, the type of the consumer who exhibits a tendency to value relationships with others (primary indicator is C) and exhibits a tendency to influence others others (secondary indicator is t) is Ct, which is the combination of the primary indicator and the secondary indicator. This indicator also has the meaning of “a person who can influence people around him or her about the product he or her has subscribed to, or that is, a person who can make good introductions” in the consumption of insurance. The consumer needs analysis module 510 analyzes consumers' needs in this way.

The customized solution providing module 530 provides a customized solution tailored to the needs of consumers for each type analyzed by the consumer needs analysis module 510. It provides personalized content and solutions based on identified consumer needs. For example, a customized product recommendation, a personalized marketing message, or a customized discount benefit may be provided to a specific consumer group.

Finally, a survey is conducted on typed consumer groups and individuals. Through this, it is possible to check the difference between the consumer's needs predicted by the model and the actual consumer experience.

Based on the survey results, the difference between the model's predictions and actual consumer feedback is analyzed. Through this, it is possible to verify the accuracy of the model and, if necessary, improve the model to provide more effective consumer customized services.

### Consumer Tendency Analysis and Typing Method Through Small Data Extraction Model

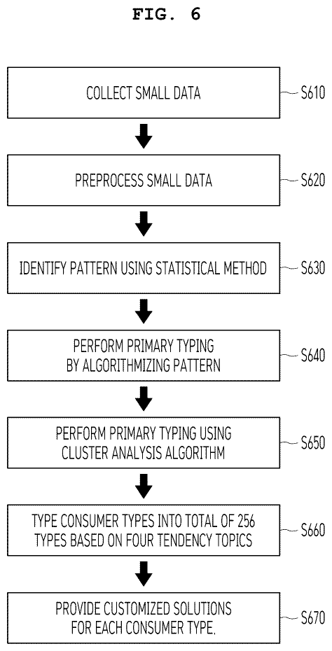

Referring to FIG. 6, a consumer tendency analysis and typing method through a small data extraction model will be described. Detailed descriptions of parts overlapping with the above description will be omitted.

First step S610: Consumer-related data of a client company is collected.

Second step S620: An error is corrected and duplicates are removed in the collected consumer-related data, and the collected consumer-related data is converted into numerical data.

Third step S630: A correlation between data is analyzed through correlation analysis and regression analysis to identify a pattern.

Fourth step S640: The identified pattern is formalized into an algorithm to primarily type the consumer-related data.

Fifth step S650: The primarily typed data is subdivided into secondary typing data using a cluster analysis algorithm.

Sixth step S660: The secondary typing data is classified according to the primary indicator based on four tendency topics of relationship attitude, way of thinking, decision-making, and lifestyle, and further classified according to the secondary indicator to classify a consumer group into a total of 256 types.

Seventh step S670: What needs consumers of each type classified based on the four tendency topics have are analyzed, and a customized solution for each consumer type is provided.

The sixth step may be configured as follows.

The primary indicators are determined for each of the four tendency topics by substituting secondary typing data into a primary indicator module.

In addition, the secondary indicators are determined for each of the four tendency topics by substituting secondary typing data into a secondary indicator module. In this case, it is determined from among the secondary indicators belonging to the primary indicator determined above.

The final typing result is output by reflecting the determinations of the first indicator and second indicator.

According to the present invention having the above-described configuration, by using zero-party data directly collected from consumers, such as visit records, inquiry records, purchase history, website activities, review data, inquiry and consultation details, and surveys, an individual's inner tendencies can be analyzed more accurately and in-depth, and a total of 256 types are possible for each customer's characteristics. Through this, customer loyalty can be increased by establishing and implementing customized marketing strategies for each consumer type.

Although the present invention has been described in detail with reference to preferred embodiments so far, those skilled in the art to which the present invention pertains may implement the present invention in other specific forms without changing the technical spirit or essential features thereof. Therefore, it should be understood that the embodiments described above are illustrative in all aspects and not restrictive.

In addition, the scope of the present invention is specified by the claims described below rather than the detailed description above, and it should be construed that all changes or modified forms derived from the meaning and scope of the claims and equivalent concepts thereof are included in the scope of the present invention.

What is claimed is:

1. A consumer tendency analysis and typing system through a small data extraction model, comprising:
a small data collection unit that collects consumer-related data of a client company;
a small data preprocessing unit that corrects errors and removes duplicates in the collected consumer-related data, and converts the collected consumer-related data into numerical data;
a pattern analysis processing unit that analyzes a relationship between preprocessed data using a statistical method to identify a pattern and algorithmizes the identified pattern to primarily type the data;
a consumer tendency detailed typing unit that secondarily types the consumer groups primarily typed by the pattern analysis processing unit using a cluster analysis algorithm, and types the secondarily typed consumer groups according to types based on four tendency topics of relationship attitude, way of thinking, decision-making, and lifestyle; and
a typing result analysis unit that analyzes what needs consumers of each type classified based on the four tendency topics have, and provides a customized solution for each consumer type.

2. The consumer tendency analysis and typing system of claim 1, wherein the same pattern analysis processing unit includes:
a pattern correlation analysis module that analyzes a correlation between data through correlation analysis and regression analysis to identify a pattern; and
a pattern algorithmization module that formalizes the identified pattern into an algorithm to primarily type consumer-related data.

3. The consumer tendency analysis and typing system of claim 1, wherein the consumer tendency detailed typing unit includes:
a cluster analysis-based consumer typing unit that subdivides the primarily typed data by the pattern analysis processing unit into secondary typing data using a cluster analysis algorithm; and
a tendency topic-based consumer typing unit that classifies the secondary typing data according to a primary indicator based on the four tendency topics of relationship attitude, way of thinking, decision-making, and lifestyle, and further classifying the secondary typing data according to a secondary indicator to classify the consumer group into a total of 256 types.

4. The consumer tendency analysis and typing system of claim 3, wherein the cluster analysis-based consumer typing unit subdivides the group within the same pattern of data primarily typed using hierarchical cluster analysis and density-based cluster analysis algorithms and secondarily types the group.

5. The consumer tendency analysis and typing system of claim 3, wherein the tendency topic-based consumer typing unit classifies customers into a total of 256 types by classifying the customers into up to 16 types using the primary indicator and classifying the customers into up to 16 types using the secondary indicator, by applying the first indicator, which is divided into two types for each of the four tendency topics of relationship attitude, way of thinking, decision-making, and lifestyle, and then applying the secondary indicator, which is divided into two additional types for each primary indicator.

6. The consumer tendency analysis and typing system of claim 3, wherein the tendency topic-based consumer typing unit includes:
a primary indicator module that types consumer tendency into two types of primary indicators for each tendency topic for the four tendency topics;
a secondary indicator module that types the primary indicator into two types of secondary indicators according to the consumer tendency;
a primary indicator determination module that determines the primary indicators for each of the four tendency topics by substituting secondary typing data subdivided by the cluster analysis-based consumer typing unit into the primary indicator module;
a secondary indicator determination module that determines the secondary indicators for each of the four tendency topics by substituting secondary typing data subdivided by the cluster analysis-based consumer typing unit into the secondary indicator module; and
a final typing module that outputs a final typing result by reflecting determinations of the primary indicator and the secondary indicator.

7. The consumer tendency analysis and typing system of claim 6, wherein the tendency topic-based consumer typing unit further includes:
a primary indicator learning module that learns, with a first artificial intelligence indicator inference engine, client company information, the secondary typing data subdivided by the cluster analysis-based consumer typing unit, one pre-written question consisting of content associated with the secondary typing data, a primary indicator matched with an answer, and primary indicator determination content of the primary indicator determination module, and infers the primary indicators for each of four tendency topics when the client company information and the secondary typing data subdivided by the cluster analysis-based consumer typing unit are input; and
a secondary indicator learning module that learns, with a second artificial intelligence indicator inference engine, client company information, secondary typing data subdivided by the cluster analysis-based consumer typing unit, three pre-written questions consisting of content associated with the secondary typing data, a second indicator matched with an answer, and second indicator determination content of the second indicator determination module, and infers the secondary indicators for each of four tendency topics when the client company information and the secondary typing data subdivided by the cluster analysis-based consumer typing unit are input, and
the final typing module outputs a final typing result by reflecting determinations of the primary indicator inferred by the primary indicator learning module and the secondary indicator inferred by the secondary indicator learning module.

8. The consumer tendency analysis and typing system of claim 1, wherein the typing result analysis unit includes:
a consumer needs analysis module that analyzes the needs of consumers for each type classified by the consumer tendency detailed typing unit; and
a customized solution providing module that provides a customized solution suitable for the needs of consumers for each type analyzed by the consumer needs analysis module.

9. A consumer tendency analysis and typing method through a small data extraction model, comprising:
a first step of collecting consumer-related data of a client company;
a second step of correcting an error and removing duplicates in the collected consumer-related data, and converting the collected consumer-related data into numerical data;
a third step of analyzing a correlation between data through correlation analysis and regression analysis to identify a pattern;
a fourth step of formalizing the identified pattern into an algorithm to primarily type the consumer-related data;
a fifth step of subdividing the primarily typed data into secondary typing data using a cluster analysis algorithm;
a sixth step of classifying the secondary typing data according to primary indicators based on four tendency topics of relationship attitude, way of thinking, decision-making, and lifestyle, and further classifying the secondary typing data according to secondary indicators to classify a consumer group into a total of 256 types; and
a seventh step of analyzing what needs consumers of each type classified based on the four tendency topics have, and providing a customized solution for each consumer type.

10. The consumer tendency analysis and typing method of claim 9, wherein the sixth step includes the steps of:
determining the primary indicators for each of the four tendency topics by substituting secondary typing data into a primary indicator module;
determining the secondary indicators for each of the four tendency topics by substituting secondary typing data into a secondary indicator module; and
outputting a final typing result by reflecting determinations of the primary indicator and the secondary indicator.
